(19) United States
(12) Patent Application Publication
(10) Pub. No.: US 2015/0154298 A1
(43) Pub. Date: Jun. 4, 2015

(54) METHOD AND SYSTEM FOR ARCHIVING AND SEARCHING WEBSITE COLLECTIONS

(71) Applicant: My Webolution LLC, Dunn Loring, VA (US)

(72) Inventors: Peter HAIG, Dunn Loring, VA (US); William HAIG, Dunn Loring, VA (US); Vlad KHOMUTOV, Toronto (CA)

(73) Assignee: My Webolution LLC, Dunn Loring, VA (US)

(21) Appl. No.: 14/560,283

(22) Filed: Dec. 4, 2014

Related U.S. Application Data
(60) Provisional application No. 61/911,691, filed on Dec. 4, 2013.

(51) Int. Cl. G06F 17/30

(52) U.S. Cl. CPC G06F 17/30864; G06F 17/3089

(57) ABSTRACT

A system includes components to allow a user to view websites. Collections of websites are stored and accessible by the user. The user views information on websites within a collection. A website is accessed through the collection and loaded into a frame environment. Thus, the user can search through collections of websites as opposed to search engine rankings to find websites of interest.

### FIELD OF THE INVENTION

The present invention relates to using saved searches or collections to enhance the user experience in selecting websites. More particularly, the present invention relates to archiving the searches and collections from users to provide improved results and rankings to these users.

### DESCRIPTION OF THE RELATED ART

When searching the internet, or World Wide Web, for specific content, a user depends on machine algorithms to find and rank the relevant results. Many of these algorithms use specific criteria, keywords or factors to obtain these results. The results may number in the hundreds or thousands. Thus, rankings within the results are extremely important.

Rankings, however, may be manipulated by search engine optimization (SEO) practices, link exchanges, placement of keywords, and the like. Search engine optimization may use black hat and white hat SEO techniques. Black hat SEO refers to techniques that are used to get higher search rankings in an unethical manner. Keyword stuffing and doorway pages are examples of these practices. White hat SEO refers to all acceptable and established means of driving traffic to a website. A company may hire a third party to optimize their rankings using these techniques.

No matter what practice is used, rankings are not necessarily based on the quality or interest of the websites to the user, but on information deemed important Lo an atgorithm, Further, companies manipulate this information for higher rankings. This process results in the same search results being provided to users, with potential websites of interest being ignored by commercial search engines.

### SUMMARY OF THE INVENTION

The disclosed embodiments create and archive collections of websites for particular topics that may be used by others. A user may generate a collection of websites that he/she deem important, and makes the collection available to others to use instead of a typical search engine queries. Each collection may belong to a specific category, such as motorcycles, running, architecture and the like. Websites added to each collection may be ranked by a community of users as the most relevant or most interesting websites about that category.

The collections created by the users of the disclosed system can be ranked by the community to further sort the content by means of collaborative curation. Thus, the disclosed embodiments may leverage community interactions to create a database of the best websites. These results are provided independent of algorithms or SEO operations. The disclosed embodiments also circumvent the tendency of the same websites to be put in front of user no matter what the search. Users can highlight lesser known websites without the need for keyword optimization processes or optimization.

A method for accessing a website over a network for viewing on a device within a browsing environment is disclosed. The method includes accessing a database storing a plurality of collections. Each collection includes information corresponding to one or more websites. The method also includes selecting a collection from the plurality of collections. The method also includes viewing graphical representations of a plurality of websites within the collection. Each website corresponds to a graphical representation. The method also includes opening a website from the collection within a frame in the browsing environment by selecting the graphical representation using the browsing environment.

A method for archiving websites for a category on a network also is disclosed. The method includes selecting one or more website pertaining to the category. The method also includes entering information for the one or more websites into a graphical user interface. The method also includes generating a collection for the category using the one or more websites. The method also includes storing the collection along with the entered information at a location within a memory coupled to the network. The method also includes providing the collection to a user. A selected website from the collection is opened in a frame within a browsing environment on the network.

A system for providing websites to a user over a network also is disclosed. The system includes a database to store a plurality of collections. Each collection includes information corresponding to one or more websites. The system also includes a device to enable a browser to display a selected collection, and the one or more websites selected by a user.

### BRIEF DESCRIPTION OF THE DRAWINGS

Various other features and attendant advantages of the present invention will be more fully appreciated as the same becomes better understood when considered in conjunction with the accompanying drawings.

FIG. 1 illustrates a client-server environment for a collection archive system according to the disclosed embodiments.

FIG. 2 illustrates a block diagram a computer system for use in retrieving and displaying website collections according to the disclosed embodiments.

FIG. 3 illustrates a configuration of a website according to the disclosed embodiments.

FIG. 4 illustrates a flow diagram for creating a collection according to the disclosed embodiments.

FIG. 5 illustrates a flow diagram for adding a website from a bookmarklet to a collection according to the disclosed embodiments.

FIG. 6 illustrates a flow diagram for exploring a collection according to the disclosed embodiments.

FIG. 7 illustrates a block diagram of an environment for displaying collections according to the disclosed embodiments.

FIG. 8 illustrates a flow diagram for a search using the collections according to the disclosed embodiments.

FIG. 9A illustrates a screenshot of an example of adding a website to a collection according to the disclosed embodiments.

FIG. 9B illustrates a screenshot of an example of adding a website to a collection according to the disclosed embodiments.

FIG. 9C illustrates a screenshot of an example of adding a website to a collection according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

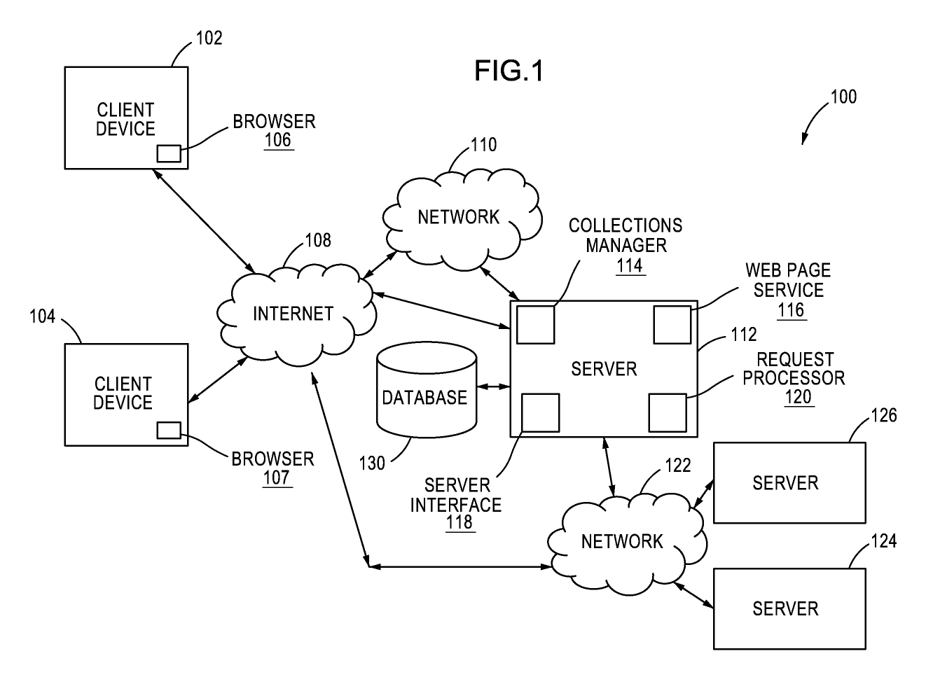

FIG. 1 illustrates a client-server environment for a collection archive system according to the disclosed embodiments. A client-server wide area network system 100 is shown. System 100 includes client devices 102 and 104 that host or execute applications for browsers 106 and 107, respectively. Clients 102 and 104, via a wide area network such as Internet 108, can achieve a connection to other networks such as network 110 and to servers such as server 112. Client devices 102 and 104 may be mobile devices, such as a smart phone or tablet. Alternatively, client devices 102 and 104 may be computers or laptops.

Server 112 connects to database 130 and to other networks such as network 122. Server 112 can include a collections manager 114, a webpage service 116, a server interface 118, and a request processor 120. Network 122 may connect to server 126, and a content server 124 such that many different websites may be provided to a client device via selectable links having network addresses. System 100 may include any number of servers connected through networks that are accessible by server 112 to retrieve information.

Browsers 106 and 107 can facilitate user-browser interactions to communicate between client devices 102 and 104, and server 112. For example, browser 106 may be enabled with computer executable code or other code that enables transmission of interaction details from client device 102 to servers 112, 124 and 126. These codes may include programming codes that can be embedded in Hypertext Markup Language (HTML) or other language of a page to provide additional functionality and is generally supported by browser 106.

When a user utilizing client device 102, such as a computer, tablet, smartphone and the like, wants to view a webpage, browser 106 transmits a network address of a webpage. Specifically, browser 106 may transmit information about a collection of webpages stored within database 130 to server 112. In turn, browser 106 displays the requested information to the user. The user may modify the collection of websites identified by the network address. Alternatively, the user may create a new collection or delete an existing one.

Content stored in database 130 or in servers 126 or 124 may be located via selectable links displayed with the collection of websites. The user can click on the links to view the content provided by the servers but in a frame environment, disclosed in greater detail below. Request processor 120 may handle these requests as needed.

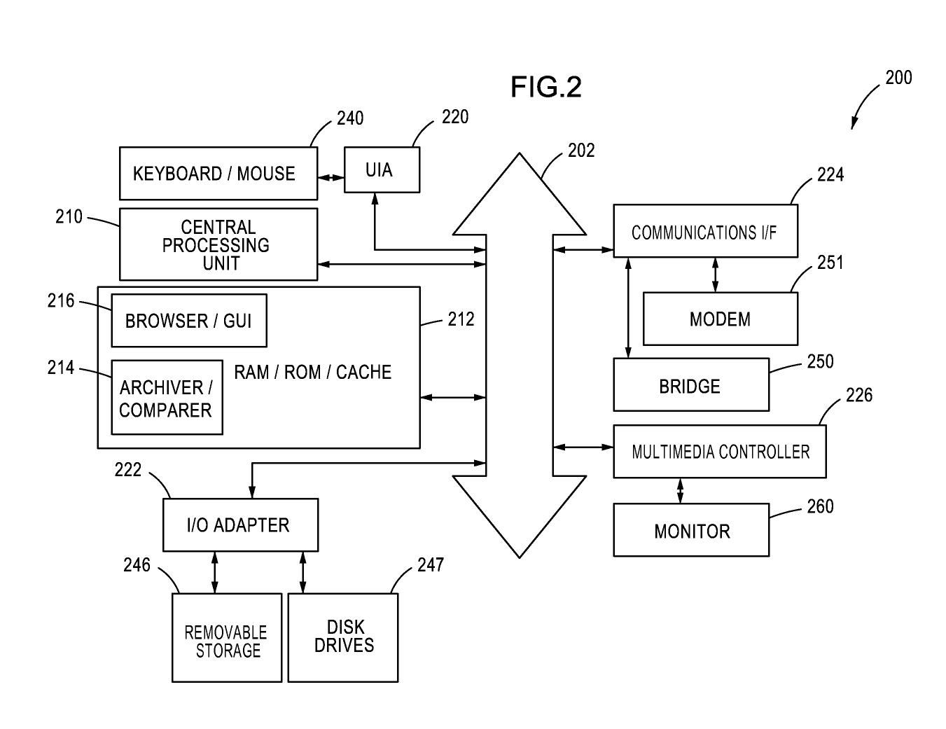

FIG. 2 depicts a block diagram of a processing device 200 utilized to provide the browser systems and methods disclosed herein. Processing device 200 may be analogous to devices 102 and 104 disclosed above. Device 200 may execute an entire suite of computer programs to provide the functionality disclosed below to allow for the archiving, ranking and retrieval of website collections. Device 200 may be a computer that can access networks, but workstations, platforms, smart phones, tablets, smart televisions, or another other processing device would not part from the scope of the disclosed embodiments.

Processing device 200 includes a processor 210. Processor 210 may be a conventional data processor, memory including random access memory (RAM), read only memory (ROM) and cache memory 212, and input/output adapter 222, a user interface adapter (UTA) 220, a communications interface adapter 224, and a multimedia controller 226. Processor 210 executes instructions to perform functions or processes. Thus, software instructions may configure processor 210 to perform a specific function to accomplish a specific goal. In other words, the disclosed embodiments configure processing device 200 into a specific machine to perform specific functions. These functions are disclosed in greater detail below.

Input/output (I/O) adapter 222 can be connected to, and control, disk drives 247, and removable storage devices 246. User interface adapter 220 can be considered to be a specialized I/O adapter. Adapter 220 is connected to a mouse and a keyboard 240. In addition, user interface adapter 220 may be connected to other devices capable of providing various types of user control, such as touch screen devices, track balls and pads, and the like.

Communications interface adapter 224 can be connected to a bridge 250 for a local or wide area network, and a modem 251. Modem 251 may be internal or external. By connecting system bus 202 to various communication devices, external access to information on a network may be achieved. Multimedia controller 226 may include a video graphics controller capable of displaying images upon monitor 260, as well as providing audio to external components, such as speakers connected to processing device 200.

A graphical user interface (GUI) module 216 can be connected to a browser, such as browser 106, to control features and content provided on monitor 260. GUI 216 also may connect to system bus 202 to provide logic or instructions to facilitate a user-browser interaction associated with retrieval of websites and information. Central processing unit 210 can execute functions and provide useful interaction tools to a user during searches and retrieval over Internet 108, and during the submission of collections.

In operation, a user operating device 200 can utilize GUI 216 to retrieve content from a remote server or server 112. Preferably, this content is a collection or group of collections. Archiver 214 stores the retrieved collection locally, in RAM/ROM/cache memory 212 or on disk drive 247. This content may be made available to the user. Using GUI 216, the user may add content or modify existing content of the collection.

After the content of a webpage is received by device 200 via communications I/F 224, and is displayed by monitor 260, a user may attempt modify the displayed contents utilizing browser 216. These modifications may be stored in memory 212. Upon completion, the modified content may be sent back to server 112.

Using these configurations, a user may log into the disclosed system to create, search and rank collections of websites. The collections are stored for later retrieval by other users. The users utilize the network, as disclosed above, to assemble the collections and information needed to create the collections.

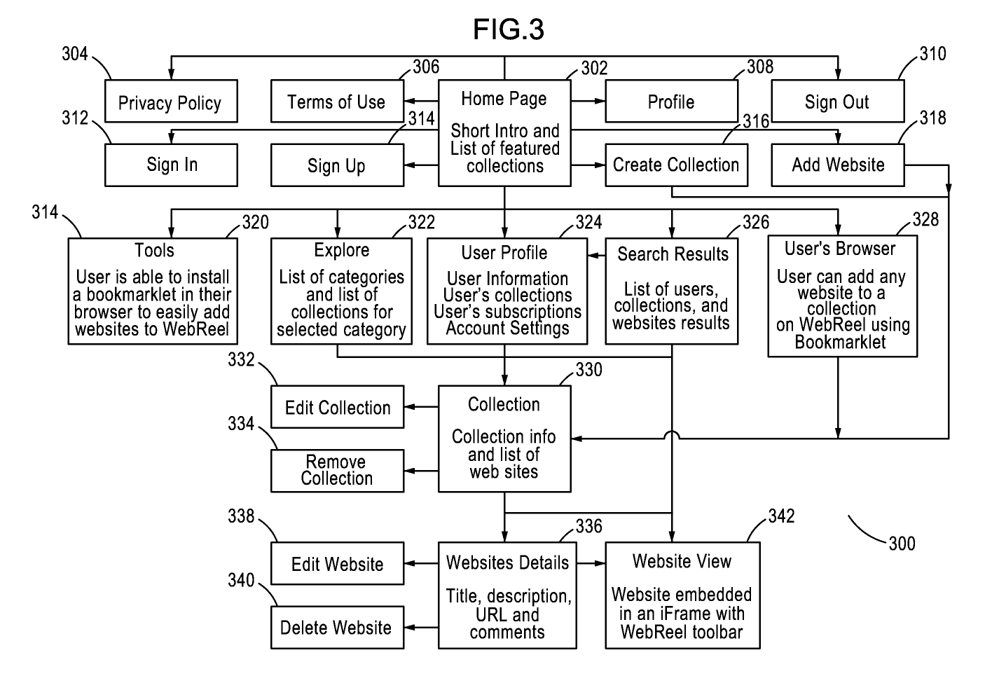

FIG. 3 depicts the configuration of a website 300 to achieve these functions. FIG. 3 shows the various webpages available along with the corresponding functions. Thus, as a user browses website 300, these pages and functions are made available to him/her. The pages shown are not exclusive, and may include other pages as needed.

Home page 302 refers to the primary page loaded onto device 200 when accessing website 300 to implement the disclosed embodiments. Home page 302 may include a short introduction and a list of featured collections. Home page 302 may be identified by the URL common to all pages within website 300. From home page 302, the user may select from a variety of options and functions. These options and functions are described in no particular order below.

Privacy policy page 304 refers to content regarding the privacy rules for users of website 300. Terms of use page 306 refer to the rules and terms for the user to follow when using the disclosed website 300. Profile page 308 may include information specific to the user. The user may enter this information when creating an account, and modify the information as desired. Sign out page 310 allows the user to exit website 300. Sign in page 312 allows the user to sign into his/her account by, for example, entering a user name and password. Sign in page 312 also prevents hackers and spammers from accessing the services provided by the disclosed embodiments. Sign up page 314 allows the user to create a new account by entering pertinent information to set up the account.

Create collection page 316 allows the user to create one or more collections. This process is disclosed in greater detail below. Add website page 318 permits the user to add a website, also disclosed in greater detail below. Other pages also may be included on website 300 to enable functionality of using collections of websites according to the disclosed embodiments.

Tools 320 provides tools to allow the user to install a bookmarklet (disclosed below) in the browser, such as browser 106, to easily add website using the disclosed embodiments. Explore function 322 provides a list of categories and a list of collections for a selected category.

User profile function 324 provides information to the user, preferably created on profile page 308. This information includes user information, collections created/saved by the user, subscriptions of the user and account settings. For example, the user may set parental controls in the settings to prevent underage users from accessing inappropriate materials.

Search function 326 provides search results on the collections accessible within the disclosed service. The user may search the collections stored within system 100. These results may include a list of users, collections and websites compiled by a search. Search function 326 may be activated by entering search terms at home page 302. The search results may be added to the user profile by user profile function 324. User's browser function 328 allows the user to add a website to a collection according to the disclosed embodiments using a bookmarklet.

Most of the above pages and functions lead the user to a collection 330. Collections are the building blocks of the data provided by the disclosed embodiments. Collection 330 includes a list of websites for a particular subject or category. Collection 330 also may include information about the websites or the collection itself, or metadata to further define the data within the collection. Collection 330 differs from a search result using a search engine in that it is not generated using algorithms or keywords, but by data selected by a user or a plurality of users. A collection generated by a friend or expert in a field may relate more to the user's needs than search results.

For example, if the category is motorcycles, a collection created by someone in the user's social network may be of greater interest than a search that turns up the same “popular” websites on motorcycles. Alternatively, a collection of websites about motorcycles created by a well-known designer may be provided which emphasizes more technical details over commercial topics. Further, the collection may emphasize websites to small business motorcycle shops over large business interests using leverage to rank high in search engine results.

Using another example, a writer of historical fiction may create a collection about the topics included in a book. These websites may be useful for further research or links to papers about the topics. The collection differs from the usual search engine results on these topics and highlights websites not readily available in the search engine results. Thus, one can create a collection of their own “results” made available to fans and friends. In certain respects, the disclosed embodiments are as if the writer did his/her own personal search for the user.

From data within collection 330, a couple functions may be executed. Hereinafter, “collection” may refer to data associated with a generated collection. Other functions may be added, but the ones disclosed below are shown for illustration. Edit collection function 332 allows the user to edit collection 330. The user may add or delete a website from the collection. The user also may rename the collection or add information about the collection for other users. Remove collection function 334 permits the user to remove collection 330 from preferences, results from search function 326 and the like.

Within collection 330, website details 336 are shown. These details may include title, description, uniform resource locator (URL), and comments. The user then may perform website view 342 by selecting a website from the collection. The content of the selected website is embedded in an iFrame using a toolbar according to the disclosed embodiments. This function is disclosed in greater detail below. Additional functions may be accessed from website details 336. Edit website function 338 allows the user to edit the details about the website. Delete website function 340 permits the user to delete the website from collection 330, provided the user has authorization to do so.

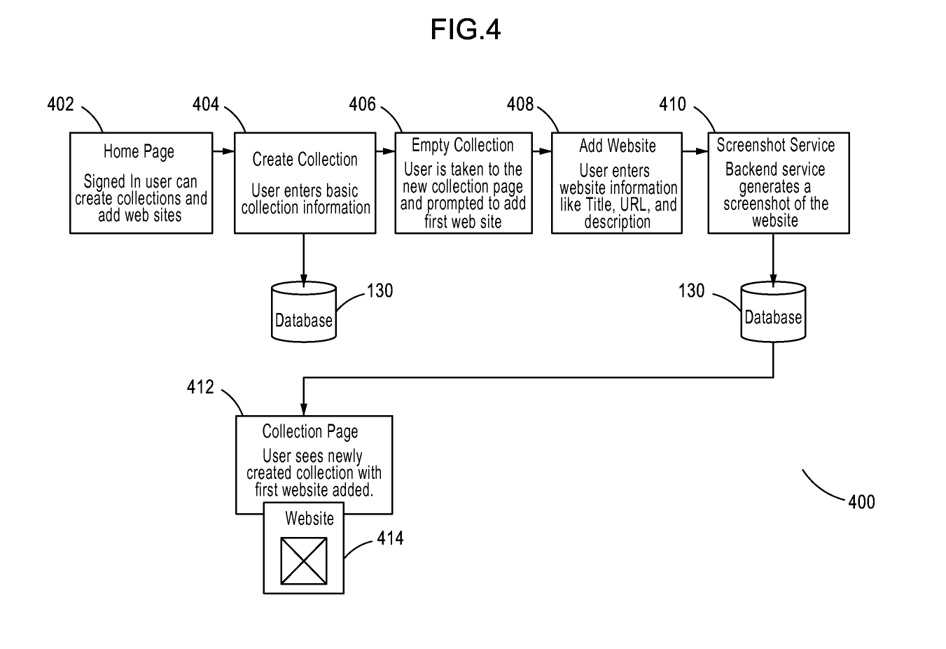

FIG. 4 depicts a flow diagram 400 for generating a collection, such as collection 330, according to the disclosed embodiments. Flow diagram 400 includes references to database 130 of FIG. 1, but any database or memory, or a plurality of such, to store data is applicable. Step 402 executes by accessing the home page for the disclosed embodiments. The user may sign in and select the option to create collections and add websites to collections. Referring back to FIG. 3, the user may go from home page 302 to create collection page 316.

Step 404 executes by generating a collection. The user indicates that he/she would like to generate a collection. A GUI or template is provided to enter information about the new collection. The user may enter basic information (subject, date, author, etc.) for the collection. This information may become metadata for the collection itself, to further help in identifying the collection in searches or lists within the community of users. This information may be transformed to generate the collection and stored to database 130.

Step 406 executes by providing an empty collection to the user. The user is taken to a new collection page and prompted to add information relating to the first website to the collection. Preferably, a GUI will allow the user to enter this information. Step 408 executes by adding the website to the collection. The user may enter basic information like title, URL and a description into the GUI or template. The user may continue to add websites to build the collection. Alternatively, the user may “paste” information from the URL into the GUI to add to the collection.

Step 410 executes by performing a screenshot of the website. The disclosed embodiments include a backend service to generate a screenshot. A static image is generated to represent the look of the added URL at the time it is added to the collection. This image may be used later when viewing the collection. The static image and user-entered website information are saved to database 130.

Flow diagram 400 then moves to step 412. Step 412 executes by allowing the user to see newly created collection with the website added. Website 414 is represented by the screenshot taken in step 410. Website 414 may act as a record for the URL in the collection. The above steps may be repeated to add multiple websites to the collection. As websites are added, the generated and captured information is stored in database 130.

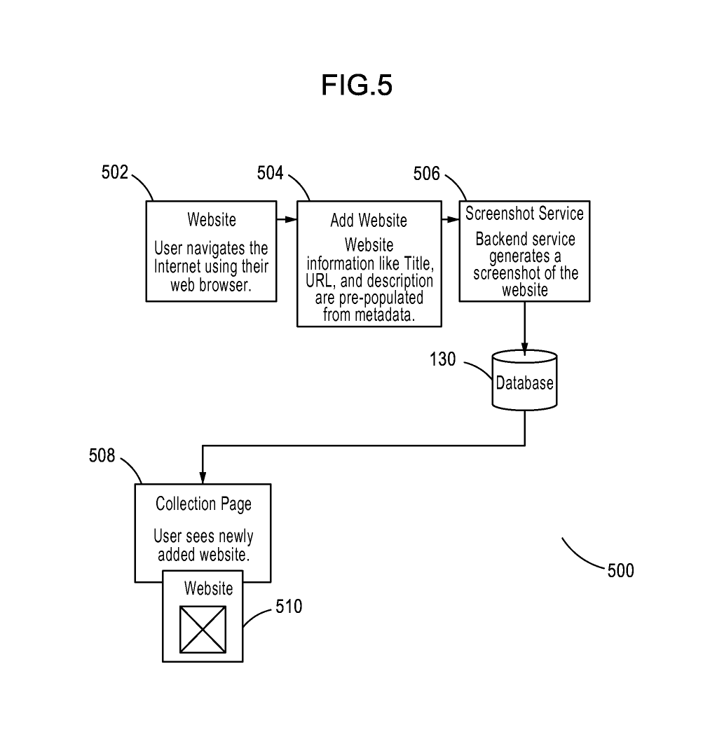

FIG. 5 depicts a flow diagram 500 for adding a website from a bookmarklet to a collection according to the disclosed embodiments. Whenever the user views a website that is interesting or relevant to a specific topic, he/she may add it to the disclosed embodiments by clicking a bookmarklet previously installed. Step 502 executes by identifying a website for addition to a collection. This action may occur while the user is navigating the Internet using their web browser. The bookmarklet may appear in the browser bookmarks bar.

A bookmarklet may represent an interactive bookmark that functions as an active tool or link within a computer network. The bookmark is stored in a web browser that contains commands to extend the browser's functionality. Bookmarklets are unobtrusive scripts stored as the URL of a bookmark in a web browser or as a hyperlink on a webpage. The bookmarklet may be placed within the bookmarks toolbar of a web browser so that webpages added to bookmarks may have the option of being added to a collection according to the disclosed embodiments. Thus, a user does not have to leave the website or perform cut-and-paste operations to add the website to a collection.

Step 504 executes by adding information for the website to a collection. The user specifies which collection to add the website. Basic website information like title, URL, and a description are pre-populated from metadata into the GUI or template. Using the bookmarklet example, if the bookmarklet is clicked, then these fields may be instantly populated using the data from the identified webpage. Step 506 executes by performing a screenshot of the website. As disclosed above, a backend service generates the screenshot of the website for archival and reference purposes. The static image of the screenshot and website information is stored in database 130.

Step 508 executes by placing website 510 into the collection. The user views the added website on the collection page. User may see a website screenshot, title, URL and description to represent website 510. This process may be repeated for additional websites. Thus, by clicking the bookmarklet, the user retrieves the data for the website to populate the fields to add to a collection. A screenshot is then taken to include with this data. The website added to the collection includes this information as well as having it stored. Thus, the disclosed embodiments do not store websites, but the information to lead the user to the website.

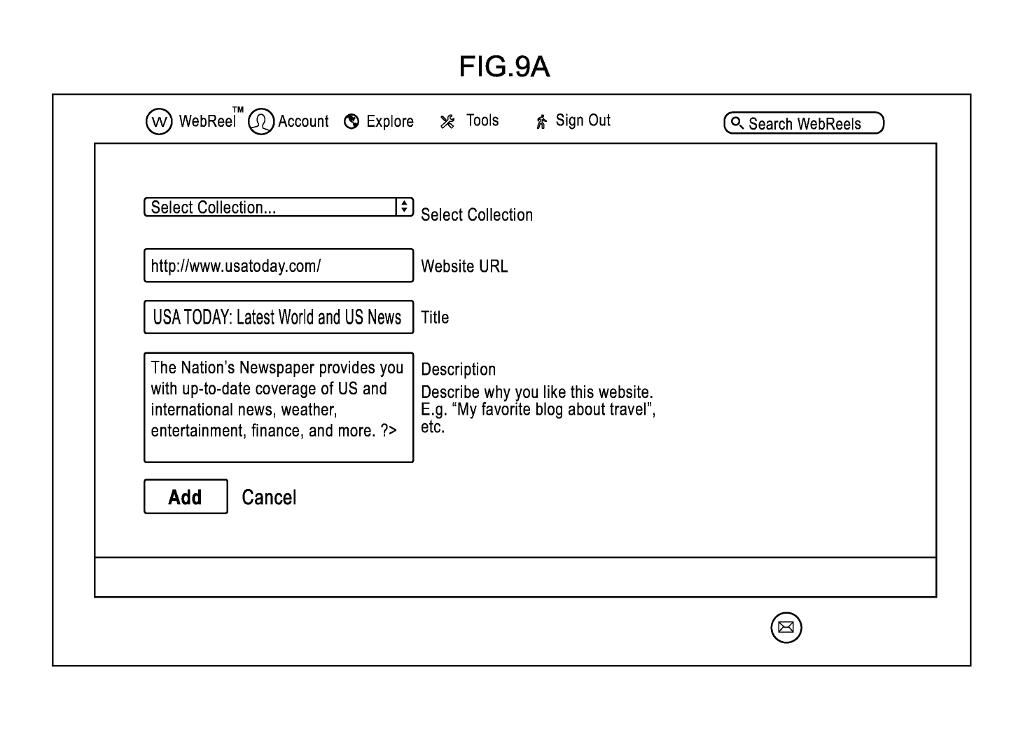

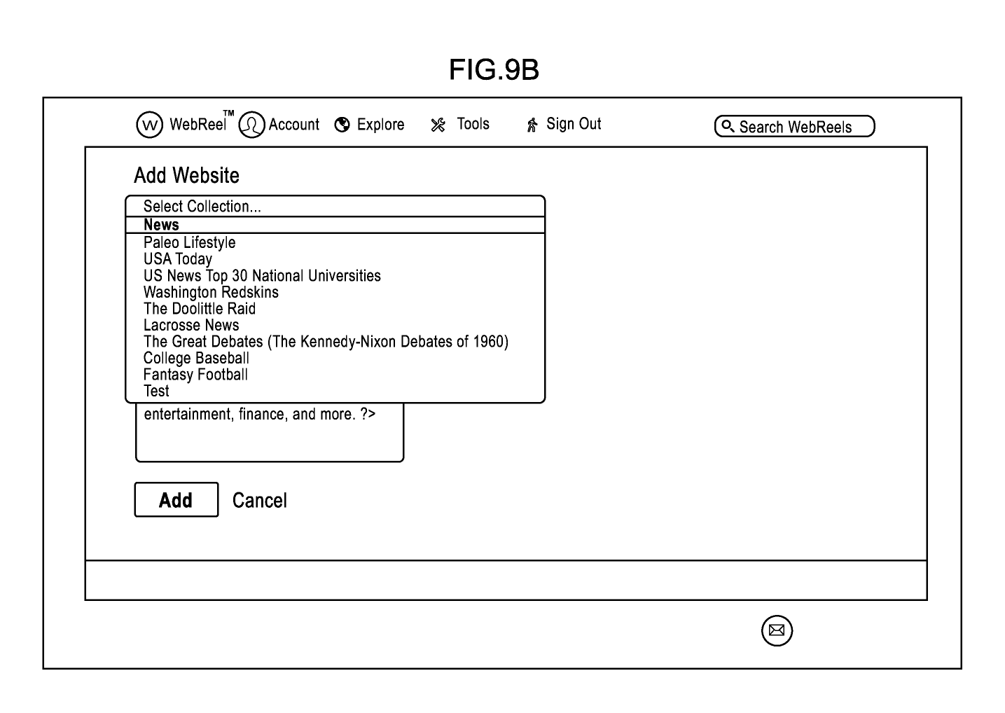

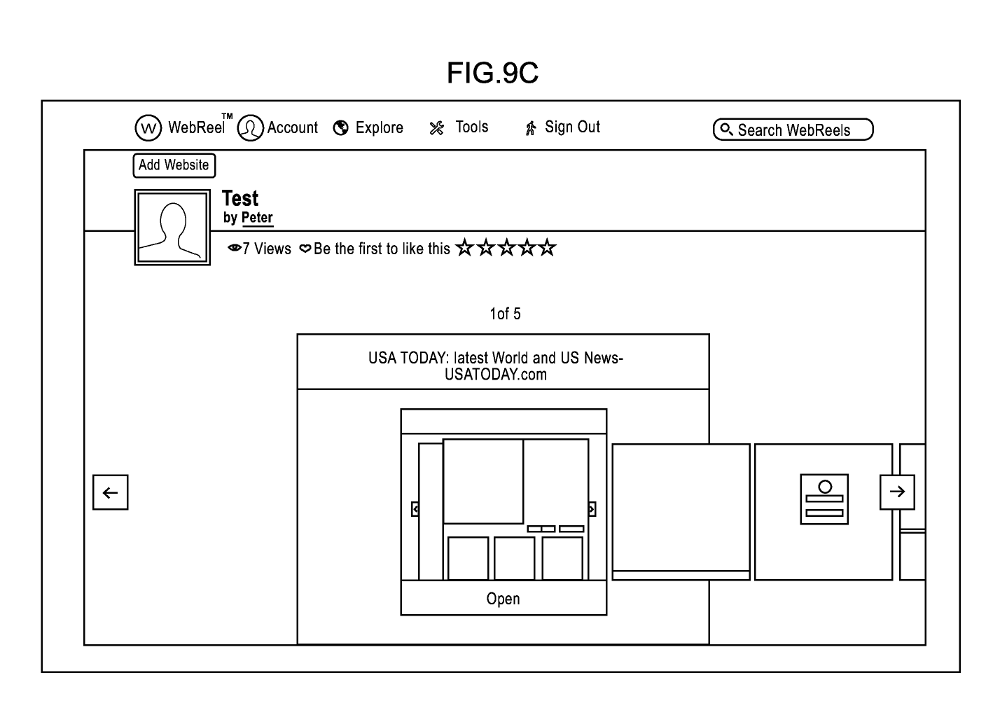

An example of this process may be shown in FIGS. 9A-C. FIG. 9A depicts the data for a website populating the fields provided in the Add Website GUI. As shown, the URL, title and a description are retrieved from the website using the bookmarklet. Alternatively, this information may be entered by the user. FIG. 9B depicts the action of adding the website to a collection. The user's collections may be listed and the user places the cursor over the name of collection to add the website. FIG. 9C depicts the screenshot of the website being added to the screenshots of the collection so that the website is visually recognizable to the user.

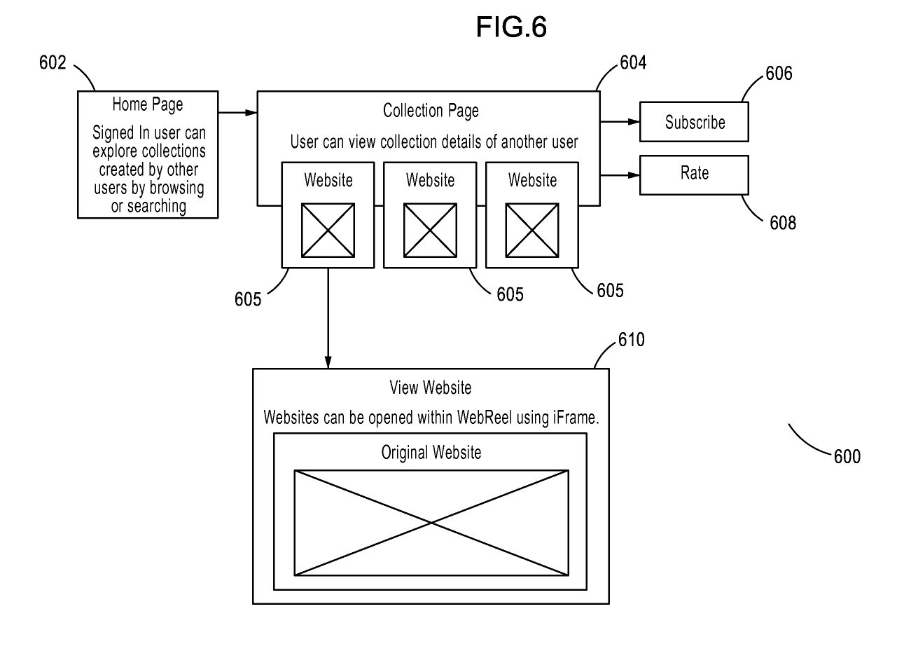

FIG. 6 depicts a flow diagram 600 for exploring a collection according to the disclosed embodiments. The user may view a collection along with associated website using the disclosed embodiments. The user then may select a website of interest to view further and browse with leaving the environment or website of the disclosed embodiments.

Step 602 executes by accessing home page 302 to explore collections created by others. The user may sign in at the home page to browse or search. The user may browse by category or identified subscriptions to various collections/categories. Step 604 executes by presenting a collection page for the collection to the user. As shown in FIG. 6, the collection includes a plurality of websites 605. Each website 605 may be identified by information, as disclosed above, such as a screenshot, title, URL and a description. Further, the user may discuss or comment on a website 605 within the collection by submitting the comments on this page. The comments may be stored with the database/server and presented to others when they view the collection.

Step 606 executes by subscribing to the collection. The collection will appear in the profile of the user as a subscription, for example, so that the user can see updates to the collection. Step 608 executes by rating the collection. This feature allows users to rank or rate website collections in order to provide the best collections to others. The disclosed embodiments may track these ratings and compare the ratings to other collections within a category, or subscription list, and the like. The rating may be saved along with the other information about the collection on the database.

Step 610 executes by viewing a website 605 from the collection using the disclosed embodiments. If the user desires to view a website in greater detail, than the website may be opened inside an iFrame. This feature allows the user to navigate the original website without leaving the website of the disclosed embodiments. The user can return to the collection at any time without the need for clicking back buttons or histories. When opened with the disclosed embodiments, the user views additional tools to navigate between the websites within a collection, share, and the like.

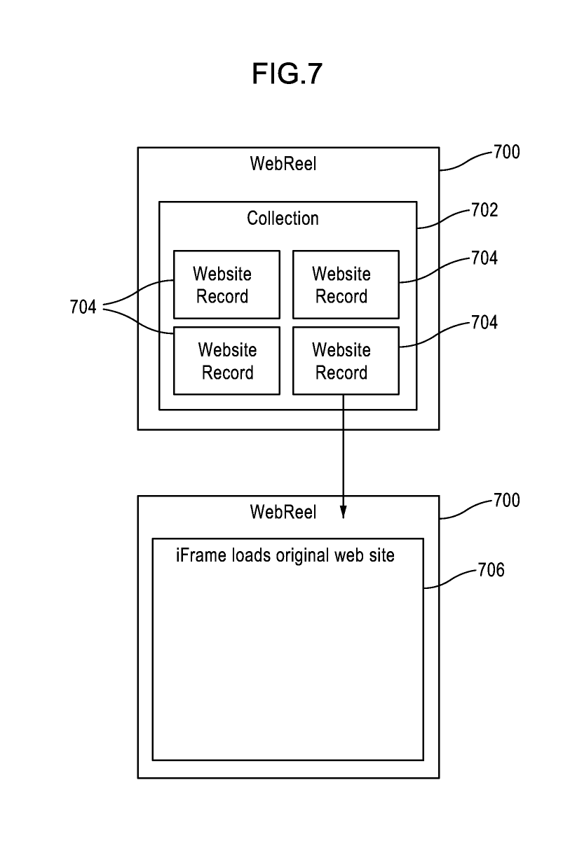

This feature may be better shown in FIG. 7. FIG. 7 depicts a block diagram of an environment 700 for displaying collections according to the disclosed embodiments.

Environment 700 may be a website itself, having the webpages disclosed above. Environment 700 includes a collection 702 selected by the user or found in a search of collections. Collection 702 includes websites 704, similar to websites 605 and the other websites in collections disclosed above. Each collection 704 includes a record of the information entered about it, such as the screenshot, title, URL and description. The record may be retrieved from the storage database.

When the user clicks or selects a website 704, the selected website 706 opens within an iFrame in environment 700. Website 706 is loaded into the iFrame. Website 706 is not copied using the disclosed embodiments. The user may navigate to other websites 704 using environment 700 without actually leaving it.

Using the embodiments disclosed by FIGS. 6 and 7, a use case may be illustrated. A user named John wants to view the best websites about “design” but finds the results of a search done by a search engine to be overwhelming. Thousands, if not millions, of results are returned. Thus, John enters web collection environment 700 to access home page 302. John signs in on sign in page 312. He looks at his subscriptions or saved collections to determine if they are applicable to designs.

If nothing turns up, then John navigates the design topic within environment 700 to see collections created by others. John sees a collection pertaining to designs created by a former professor or friend. John selects that collection to view, and it brings up websites relating to “designs.” John decides to subscribe to this collection, as he sees where the professor edits the collection on a regular basis. He also rates the collection to rank it high within the design category within the environment 700.

In the listing of websites, a screenshot catches the eye of John. He reviews the description and becomes interested in the website, so he clicks the link provided in the collection. The website opens in an iFrame so he can see how the website looks now. He reads the content and returns back to the collection page when completed.

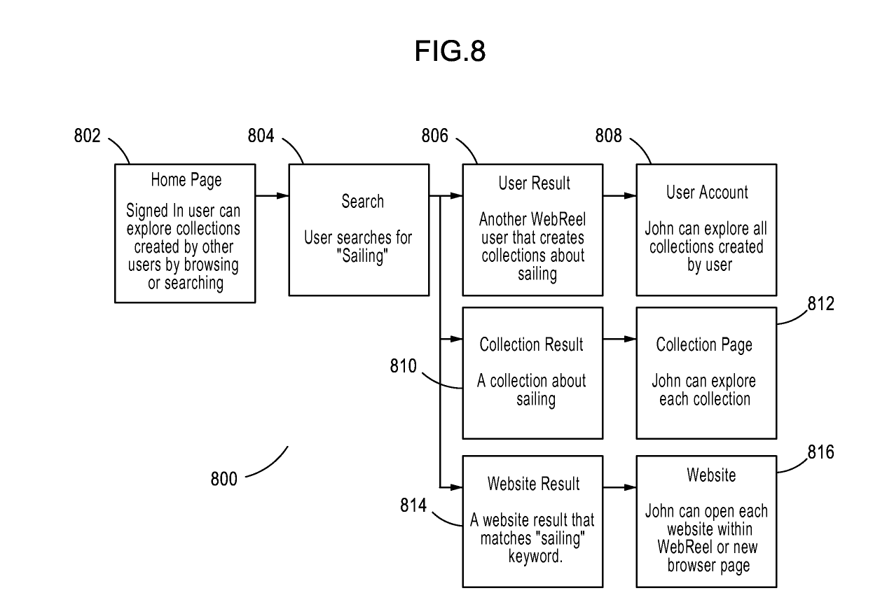

FIG. 8 depicts a flow diagram 800 for a search using the collections according to the disclosed embodiments. For example, John wants to find the best websites about “sailing” but the search engine results return hundreds or thousands of results. Sponsored content or other targeted websites are ranked higher than potential websites of interest.

Thus, John goes to environment 700. Thus, step 802 executes by John accessing home page 302 to sign in and explore collections. John may browse or search from home page 302. John selects the search feature. Step 804 executes by searching for “sailing” within the collections stored within the database or server. The search may use an algorithm or criteria in selected collections for John to view. Thus, the algorithm may first present those collections generated by friends or contacts within John's social network. Alternatively, it may include those authors/creators identified by John. The algorithm may order the collections according the rankings given within the community, and then from newest to oldest. The disclosed embodiments may use any process to order the collections.

The results may be presented to John in a variety of ways. Step 806 executes by providing a user result for viewing. The collection shown was created by another user about sailing. Step 808 executes by viewing the user account. John can explore all collections created by the user of the identified collection. John also may subscribe to collections of the user.

Step 810 executes by providing a collection result. The collections listed in the result may be about sailing. The collections provided may be based on rankings/ratings by others, a social media relationship with John, or other matching criteria. The collections may be the latest ones created within environment 700. Step 812 executes by John exploring each collection returned.

Step 814 executes by providing a website result. The website may match sailing to a keyword in the website. This step may be useful when no collection or category has been created for the search topic. Thus, John still does not have to resort to search engine results to find a website. Step 816 executes by accessing the website. John can open the website within environment 700 using the iFrame feature, or may open a new browser page.

The disclosed embodiments may be supported and executed on a platform that has access to a network. The platform may support software and executable programs to provide the functionality disclosed above. For instance, the software may be deployed. Any software embodying the disclosed algorithm and its processes may be deployed by manually loading directly to the client, server and proxy computers via loading a storage medium such a CD,

DVD, flash memory, chip, downloadable program and the like. The software also may be automatically or semi-automatically deployed into a computer system by sending the process software to a central server or a group of central servers. The software is downloaded into the client computers that execute the programs and instructions associated with the software.

Alternatively, the software may be sent directly to the client system via email. The software may be detached to a directory or loaded into a directory by a button on the email that executes a program that detaches the software into a directory. Another alternative is to send the software directly to a directory on the client computer hard drive. When there are proxy servers, the disclosed embodiments will select the proxy server code, determine on which computers to place the proxy servers' code, transmit the proxy server code, and install the proxy server code on the proxy computer. The software may be transmitted to the proxy server and then stored on the proxy server.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more computer systems coupled to a network capable of exchanging information and data. These computer systems also may be general-purpose computer systems. Various functions and components of the computer system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for accessing a website over a network for viewing on a device within a browsing environment, the method comprising:
accessing a database storing a plurality of collections, wherein each collection includes information corresponding to one or more websites;
selecting a collection from the plurality of collections;
viewing graphical representations of a plurality of websites within the collection, wherein each website corresponds to a graphical representation; and
opening a website from the collection within a frame in the browsing environment by selecting the graphical representation using the browsing environment.

2. The method of claim 1, further comprising searching the database for the collection from the plurality of collections.

3. The method of claim 1, further comprising adding the website to the collection.

4. The method of claim 3, further comprising storing the graphical representation of the website in a data storage location corresponding to the collection.

5. The method of claim 4, wherein the graphical representation is a screenshot of the website.

6. The method of claim 3, wherein the adding step includes entering data for the website using the browsing environment that uniquely identifies the website.

7. The method of claim 1, further comprising rating the collection using the browsing environment.

8. The method of claim 1, further comprising subscribing to an update of the collection.

9. The method of claim 1, further comprising adding a new website to the collection by performing an operation using a browser within the browsing environment to populate data needed to uniquely identify the new website within the collection.

10. A method for archiving websites for a category on a network, the method comprising:
selecting one or more websites pertaining to the category;
entering information for the one or more websites into a graphical user interface;
generating a collection for the category using the one or more websites;
storing the collection along with the entered information at a location within a memory coupled to the network; and
providing the collection to a user, wherein a selected website from the collection is opened in a frame within a browsing environment on the network.

11. The method of claim 10, further comprising capturing a screenshot for each of the one or more websites, and storing the screenshot with the entered information.

12. The method of claim 10, wherein the entering step includes entering information pertaining to one of a uniform resource locator, a description of the one or more websites or a title for the one or more website.

13. The method of claim 10, further comprising loading the selected website into the frame within the browsing environment.

14. The method of claim 10, further comprising associating the collection with the user.

15. A system for providing websites to a user over a network, the system comprising:
a database to store a plurality of collections, wherein each collection includes information corresponding to one or more websites; and
a device to enable a browser to display a selected collection, and the one or more websites selected by a user.
